(19) United States
(12) Patent Application Publication
(10) Pub. No.: US 2011/0270141 A1
(43) Pub. Date: Nov. 3, 2011

(54) HAIR BAND TYPE APPARATUS FOR PREVENTING SLEEPINESS

(76) Inventor: Kyung Bok YE, Seoul (KR)

(21) Appl. No.: 13/179,649

(22) Filed: Jul. 11, 2011

Related U.S. Application Data
(63) Continuation of application No. PCT/KR2010/000519, filed on Jan. 28, 2010.

(51) Int. Cl. A61H 1/00

(52) U.S. Cl. 601/46

(57) ABSTRACT

The hair-band type apparatus 100 for preventing sleepiness of the present invention comprises a wearing part 110 formed to be mounted on the head, in specific, the back of the head of a user, a stimulating part 130 installed on the both ends of the wearing part 110 for stimulating the neighborhood of the temple in various types such as pressing, beating, and rubbing and so on; and an operating part 150 installed on the middle of the wearing part 110 for operating the stimulating part 130.

### REFERENCE TO RELATED APPLICATIONS

This application is a continuation of PCT international application Ser. No. PCT/KR2010/000519 filed on Jan. 28, 2010 which designates the United States, the entire contents of which are incorporated herein by reference.

### FIELD OF THE INVENTION

The present invention relates to a hair-band type apparatus for preventing sleepiness, and more particularly, to a hair-band type apparatus for preventing sleepiness enabling to prevent user's sleepiness by stimulating the neighborhood of the temple of the user.

### BACKGROUND OF THE INVENTION

Sleepiness is one of phenomenon which may be raised when human is tired, and it is usually come to worker having long time working and it easily raises dangerous situation. In specific, long time driving, more specifically night long time driving alone much easily and frequently raises sleepiness, but there is no way to prevent the sleepiness except for even short rest or sleep. However, most vehicle drivers usually drive without enough rest or sleep because of their intensive work, and therefore the frequency of vehicular accidents is not decreased.

### SUMMARY OF THE INVENTION

The present invention is created to solve a problem of the above-mentioned prior art, and accordingly the object of the present invention provides a hair-band type apparatus for preventing sleepiness enabling to prevent user's sleepiness without the cease of the work within short time by stimulating the neighborhood of the temple of the user.

In order to achieve the above-described object, the present invention provides a hair-band type apparatus for preventing sleepiness comprising a wearing part formed to be mounted on the head, in specific, the back of the head of a user, a stimulating part installed on the both ends of the wearing part for stimulating the neighborhood of the temple in various types such as pressing, beating, and rubbing and so on; and an operating part installed on the middle of the wearing part for operating the stimulating part.

In the hair-band type apparatus for preventing sleepiness, the wearing part may include a C-shaped first ring member and a pair of arc-shaped second ring members to be inserted in the both ends of the first ring member.

Herein, the first ring member may be formed with positioning grooves on the upper and lower ends or one of the upper and lower ends, and the second ring member may receive the first ring member and it may be formed with positioning protrusions corresponding to the positioning grooves on the upper and lower ends or one of the upper and lower ends of inside thereof. Further, the first and second ring members may be respectively provided with male or female-shaped jaws which are hooked from each other.

Further, the stimulating part may be formed with an inserting protrusion to be detachably installed on the wearing part, and the wearing part may be formed with an inserting hole corresponding to the inserting protrusion.

Further, the stimulating part includes a vibrating element for generating vibration, plus and minus electrodes electrically connected to the vibrating element, and an insulating member for electrically insulating the plus and minus electrodes from each other.

Herein, the vibrating element may be a low frequency vibrating element, and the stimulating part may be further provided with a protecting layer at a portion which is closely contacted to the neighborhood of the temple such that the stimulating part is protected from outside.

Further, the operating part may be provided with a rechargeable or a non-rechargeable battery, and also it is provided with a plurality of buttons functions on/off, strength or select mode.

According to the present invention, the hair-band type apparatus for preventing sleepiness can prevent user's sleepiness without the cease of the work during short time because the neighborhood of the temple of the user is stimulated in various types such as pressing, beating, and rubbing and so on.

### BRIEF DESCRIPTION OF THE DRAWINGS

The above and other objects and advantages of the present invention will become readily apparent by reference to the following detailed description when considered in conjunction with the accompanying drawing wherein:

FIG. 1 is a perspective view schematically illustrating a hair-band type apparatus for preventing sleepiness according to a preferred embodiment of the present invention;

FIG. 2 is a cross-sectional view of the hair-band type apparatus for preventing sleepiness in FIG. 1.

FIG. 3 is a broken perspective view schematically illustrating a vibrating element of FIG. 1;

FIG. 4 is a cross-sectional view schematically illustrating the assembled condition of the vibrating element of FIG. 3; and

FIG. 5 is a block diagram schematically illustrating the connective relationship among a battery, a vibrating element, on/off button, strength button, select button, (+) electrode and (−) electrode.

### DETAILED DESCRIPTION OF THE INVENTION

Hereinafter, a hair-band type apparatus for preventing sleepiness according to preferred embodiment of the present invention will be described in detail with reference to the accompanying drawings.

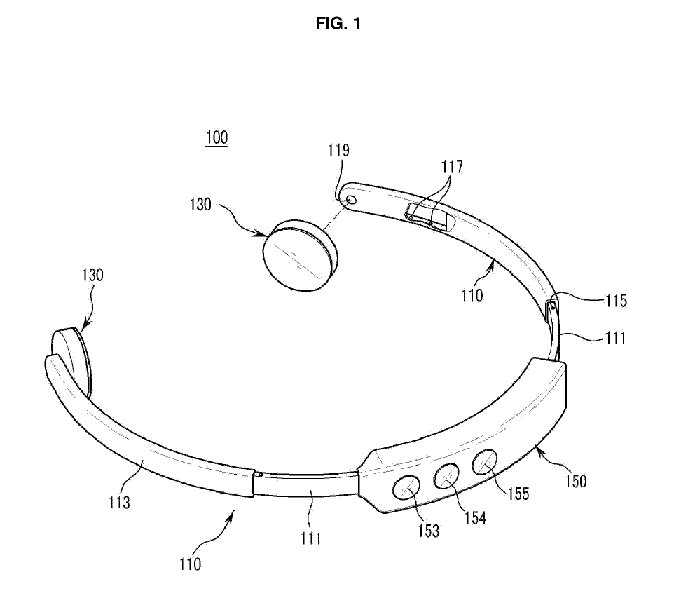

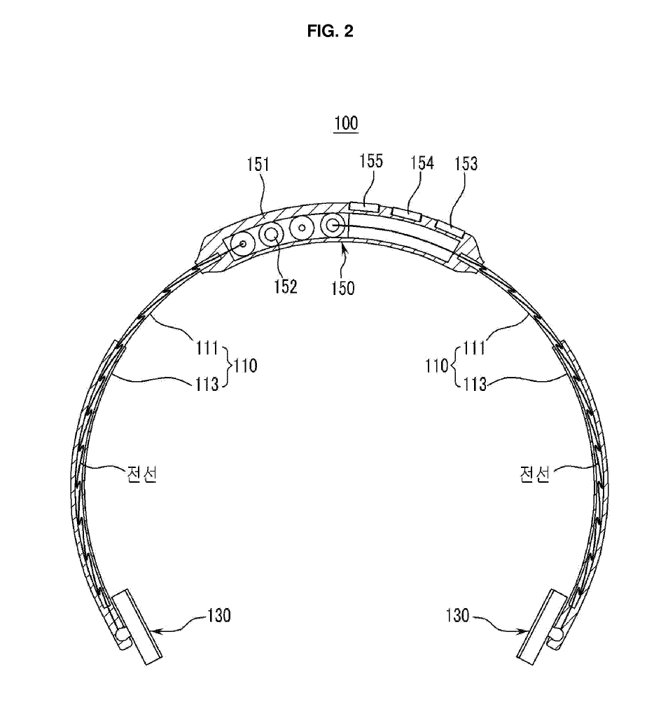

As shown in FIGS. 1 and 2, the hair-band type apparatus 100 for preventing sleepiness according to this embodiment comprises a wearing par 110, a stimulating part 130 and an operating part 150.

The wearing part 110 is to be mounted on the head of a user, in specific, the back of the head of the user, and it is comprised of a C-shaped first ring member 111 and a pair of arc-shaped second ring members 113 to be inserted in the both ends of the first ring member 111.

The first ring member 111 is made of thin and hard metal or plastic material to have a bending force, and it is hollow to receive electric wires. The first ring member 111 has both end portions where positioning grooves 115 are formed on both or one of the upper and lower ends thereof with a constant gap. Also, the both end portions, even not specifically described herein, is provided with a male or female-shaped jaw thereon to be not disassembled from the second ring member 113.

The pair of second ring members 113 is made of thin and hard metal or plastic material to have a bending force as like the first ring member 111, and it is hollow to receive the first ring member 111 and electric wires. The second ring members 113 is formed with positioning protrusions 117 corresponding to the positioning grooves 115 on the upper and lower ends or one of the upper and lower ends of inside thereof. Also, the end portion, even not specifically described herein, is provided with a male or female-shaped jaw thereon to be not disassembled from the first ring member 111. Further, the pair of second ring members 113 is formed with an inserting hole 119 near its free end in which the stimulating part 130 is inserted.

As described above, since the wearing part 110 is manufactured in twofold structure with two members, the stimulating part 130 installed on the both ends of the wearing part 110 may be further powerfully closely contacted on the neighborhood of the temple of the user.

The stimulating part 130 is to stimulate the neighborhood of the temple of the user, and it will give the stimulation in various types such as pressing, beating, and rubbing and so on.

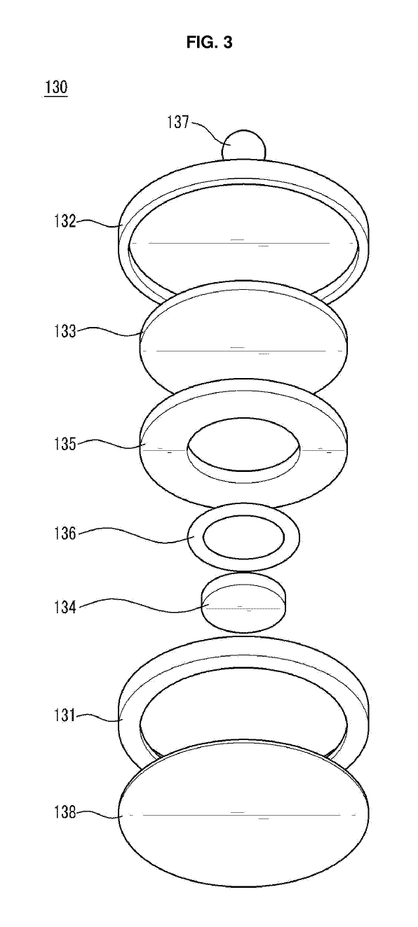

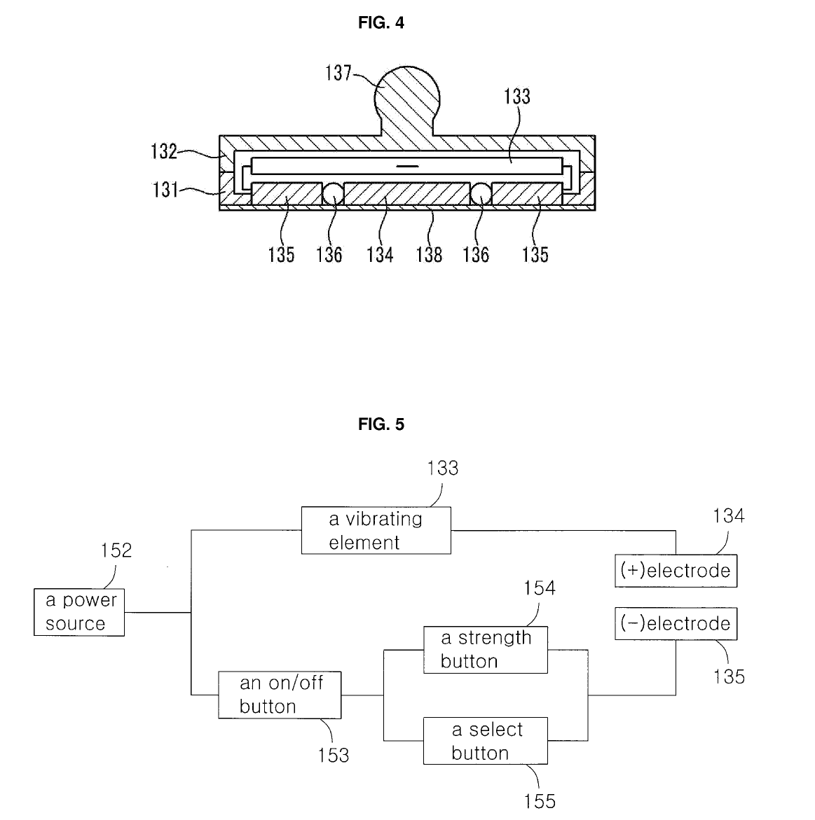

As shown in FIGS. 3 and 4, the stimulating part 130 is composed of a base plate 131, a cover 132, a vibrating element 133, plus and minus conductivity rubber plates 134 and 135 and an annular insulating member 136.

The vibrating element 133, the plus and minus conductivity rubber plates 134 and 135, and the annular insulating member 136 are fixedly disposed on the base plate 131, and the upper surface of the base plate 131 is detachably covered with the cover 132. The cover 132 is formed with an inserting protrusion 137 thereon which is inserted in the inserting hole 119 formed on the second ring members 113 of the wearing part 110.

As the vibrating element 133, a low frequency vibrating element 133 is preferably applied to generate vibration. The plus and minus conductivity rubber plates 134 and 135 are electrically connected with the vibrating element 133, and also they are isolated from each other in mechanically and electrically by the insulating member 136.

The stimulating part 130 is further provided with a protecting layer 138 for protecting the base plate 131 on the outer surface of the base plate 131.

The operating part 150 is to operate and control the stimulating part 130, and it is composed of a body 151, a power 152 and a plurality of buttons 153, 154 and 155. The body 151 is non-detachably or detachably fixedly connected to the first ring member 111 of the wearing part 110, and it is provided with an empty space to be installed with a battery 152 as a power source.

The battery 152 may be applied in a rechargeable or a non-rechargeable type, and a charging jack to be able to be connected to an outer power source is provided when it is rechargeable type, or the battery may be replaced with new ones when it is non-rechargeable type. The non-rechargeable type battery is may applied with a bar type one or a circular type one such as a mercury cell which are widely sold in the open market.

The plurality of buttons 153, 154 and 155 may be selected to function on/off mode, strength mode or select mode of the kinds of stimulation, for example, pressing, beating, and rubbing and so on.

The elements described in above, for example, may be electrically connected from each other in the manner as like in FIG. 5. The batter 152 which is a power source is connected with the vibration element 133 and the on/off button 153 in parallel, and the strength button 154 and the select button 155 are further connected with the on/off button 153 in parallel, and the plus electrode 134 and the minus electrode 135 are respectively connected with the vibrating element 133 and the select button 155 in serial. However, alternatively, any connective structure may be applied without limitation if it can operate the structure of the present invention.

Although the preferred embodiment of the present invention have been described, it is understood that the present invention should not be limited to this preferred embodiment but various changes and modifications can be made by one skilled in the art within the sprit and scope of the present invention aimed.

What is claimed is:

1. A hair-band type apparatus for preventing sleepiness, the apparatus comprising:
a wearing part formed to be hollowed to have a bending force, formed to be mounted on the back of the head to cover side of the head of a user, and being comprised of a C-shaped first ring member and a pair of arc-shaped second ring members to be inserted in the both ends of the first ring member;
a stimulating part installed on the both ends of the wearing part to be closely contacted to the neighborhood of the temple of the user for stimulating the neighborhood of the temple in various types such as pressing, beating, and rubbing and so on; and
an operating part installed on the middle of the wearing part for operating the stimulating part.

2. The hair-band type apparatus for preventing sleepiness according to claim 1, wherein the first ring member is formed with positioning grooves on the upper and lower ends or one of the upper and lower ends, and the second ring member receives the first ring member and it is formed with positioning protrusions corresponding to the positioning grooves on the upper and lower ends or one of the upper and lower ends of inside thereof.

3. The hair-band type apparatus for preventing sleepiness according to claim 2, wherein the first and second ring members are respectively provided with male or female-shaped jaws which are hooked from each other.

4. The hair-band type apparatus for preventing sleepiness according to claim 1, wherein the stimulating part is formed with an inserting protrusion to be detachably installed on the wearing part, and the wearing part is formed with an inserting hole corresponding to the inserting protrusion.

5. The hair-band type apparatus for preventing sleepiness according to claim 1, wherein the stimulating part includes a vibrating element for generating vibration, plus and minus electrodes electrically connected to the vibrating element, and an insulating member for electrically insulating the plus and minus electrodes from each other.

6. The hair-band type apparatus for preventing sleepiness according to claim 5, wherein the vibrating element is a low frequency vibrating element.

7. The hair-band type apparatus for preventing sleepiness according to claim 5, wherein the stimulating part is further provided with a protecting layer at a portion which is closely contacted to the neighborhood of the temple such that the stimulating part is protected from outside.

8. The hair-band type apparatus for preventing sleepiness according to claim 1, wherein the operating part is provided with a rechargeable or a non-rechargeable battery, and also it is provided with a plurality of buttons functions on/off, strength or select mode.
